(19) United States
(12) Patent Application Publication
(10) Pub. No.: US 2023/0374215 A1
(43) Pub. Date: Nov. 23, 2023

(54) NEW POLYAMIDE-CONTAINING POWDERS FOR POWDER BED FUSION PRINTING PROCESS AND PRINTED ARTICLES THEREOF

(71) Applicant: BASF SE, Ludwigshafen am Rhein (DE)

(72) Inventors: Laurent GOUJARD, Frontonas (FR); Jérôme GIMENEZ, Frontonas (FR)

(21) Appl. No.: 18/028,772

(22) PCT Filed: Sep. 28, 2021
(86) PCT No.: PCT/EP2021/076606

§ 371 Date: Mar. 28, 2023

(30) Foreign Application Priority Data
Sep. 30, 2020 (EP) 20306124.7

(51) Int. Cl. C08G 69/26; C08G 69/30; B33Y 70/00; B33Y 80/00; C08K 5/521; C08K 3/36; C08J 3/12

(52) U.S. Cl. CPC C08G 69/265; C08G 69/30; B33Y 70/00; B33Y 80/00; C08K 5/521; C08K 3/36; C08J 3/12; C08J 2377/06

(57) ABSTRACT

The invention relates to a 3D printable powder composition comprising a polyamide and less than 5 wt % by weight of at least one filler. The invention also relates to the process for preparing the 3D printable powder, and its use for the preparation of a 3D printed article.

The invention relates to a 3D printable powder that may be used in an additive process for the preparation of a three-dimensional article. According to the invention, the 3D printable powder comprises a polyamide prepared by reacting a particular diamine, a particular diacid and optional additional comonomer(s).

A turning point has been reached in the last few years with the emergence of three-dimensional (3D) printing techniques allowing the production of custom and low-cost 3D articles. Using such technique, the 3D article is produced layer by layer. For this purpose, by means of upstream computer-aided design software (CAD), the 3D structure of the 3D article to be obtained is divided up into slices. The 3D article is then created by laying down successive slices or layers of material until the entire 3D article is produced. In other words, the slices are produced one by one in the form of layers, by carrying out the following binary sequence repeatedly:
depositing a layer of the material necessary for producing the desired article on a platform or on an existing consolidated layer, followed by
agglomerating said layer and bonding said layer to the precedent if present in accordance with the predefined pattern.

Thus, the 3D article is constructed by superposing elementary layers that are bonded one to another.

Conventional 3D printing processes are limited to particular types of materials. These materials should be resistant to heat (i.e. no degradation should occur upon heating during the additive process), to moisture, to radiation and to weathering, and should have a slow solidification time. Importantly, the slices or layers should adhere to one another in order to produce a 3D article with satisfactory mechanical strength that will not collapse. Ideally, the material should also have a low melting temperature and an appropriate viscosity or flowability.

Importantly, after the additive process, the obtained 3D articles should have the desired properties such as mechanical properties, and shoud be of the exact desired dimensions and shape.

The material is usually composed of polymer(s) in combination with additives that are used to tailor the properties of the material and of the resulting 3D articles. For example, dyes, fillers, viscosity agents or flowing aids are commonly added. Fillers are very important as they have an impact on thermal conductivity. Thermal conductivity is of importance during the additive process. Flow aids are used to adapt the flowability of the material in order to be used in the additive process.

The suitability of a polymer depends on its thermal and physical properties, which depend from its chemical structure. Both its melting temperature and its crystallization temperature are important since they must allow the effective sintering of the resulting powder and a satisfactory strengthening of the final 3D printed article. Ideally, the thermal conductivity is high and as well as its processing window (which is defined as the difference between the onset melting temperature and the onset cristallization temperature). A processing window of at least 10° C. seems to be required in order to be used in an additive process.

Moreover, to avoid brittleness in the resulting 3D printed article, high modulus and/or strength at break and/or elongation at breask are mandatory.

Another issue is the cost of these materials. Indeed, these materials and their preparation may be expensive.

The most frequently employed polymers in additive techniques such as selective laser sintering (SLS) technology are polyamides (PA), mostly polyamide 12 and polyamide 11. Other semi-cristalline polymers are used such as polypropylene, polyethylene and polyacetals. Amorphous polymers such as polycarbonates and polystyrene have also been used.

Good results have been achieved with polyamides. Commercial polyamide 12 (such as Orgasol® sold by Arkema) has a sintering window of 20-30° C., a Young modulus of 1.7-1.8 GPa, a strength at break of 40-45 MPa and an elongation at break of 15-20%.

Satisfactory results have also been achieved with polyolefins. For example, polypropylene has a sintering window of 20-35° C.

Furthermore, during the additive process, a portion of the deposited layer is not agglomerated, depending on the predefined pattern. It is desirable to reuse this non-agglomerated material for the preparation of another 3D article.

In order to further improve the thermal and mechanical properties, research has been carried out on polymers. In particular, research has focused on polyamides since they provided good results so far. For example, patent application WO 2018/229126 describes the use of a polyamide of the following formula:

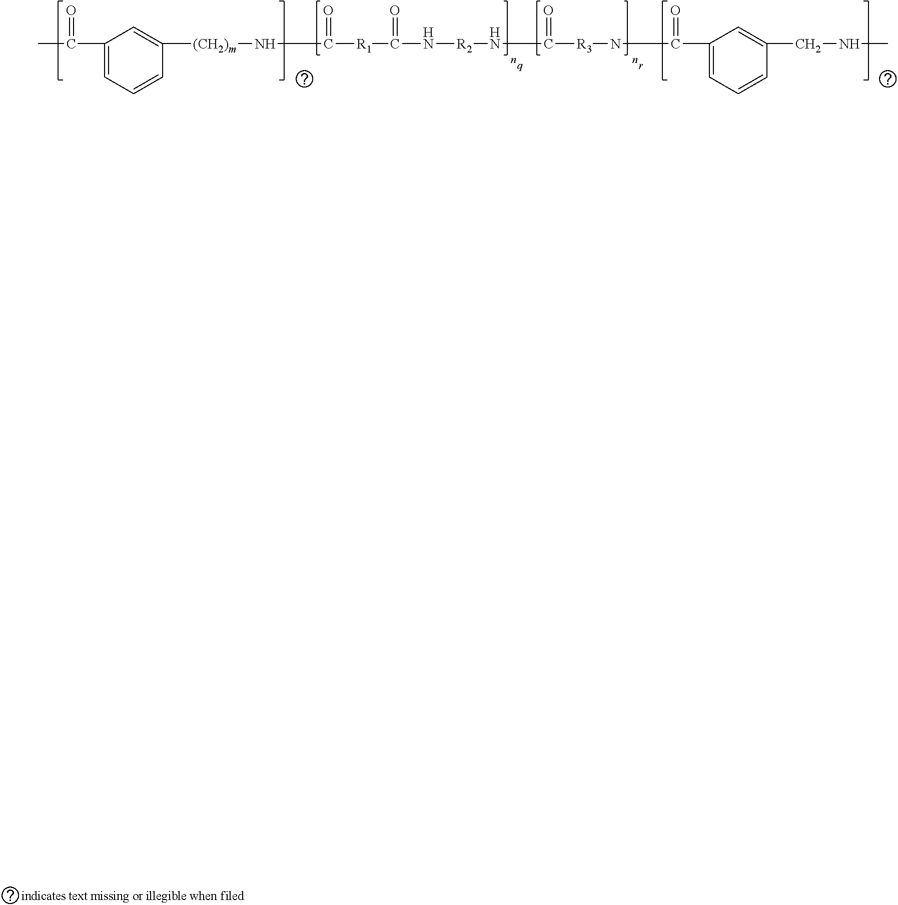

with nₚ+nₚ+nᵣ+nₛ=100, 1≤np≤100, 1<m≤20, R1 selected from the group consisting of a bond, a C1-C15 alkyl and a C6-C30 aryl optionally comprising heteroatoms and optionally substituted, R2 selected from the group consisting of C1-C20 alkyl and a C6-C30 aryl optionally comprising heteroatoms and optionally substituted, and R3 selected from the group consisting of a C2-C20 alkyl and a C6-C30 aryl optionally comprising heteroatoms and optionally substituted. These copolyamides are reported to have a high transition glass temperature and a low melting temperature. The mechanical properties and the recyclability were not evaluated.

Polyamides MXD.6 (obtained from m-xylylenediamine and adipic acid) and MXD.10 (obtained from m-xylylenediamine and sebacic acid) were also reported for their use in additive technique, and in particular SLS, in patent applications US 2020/0010627, WO 2020/165541, US 2016/0215092 and WO 2018229126. No data were provided on the processing window, on the mechanical properties, or on the recyclability of these polyamides.

Therefore, there is a need for a material for use in an additive process having the above mentioned properties (e.g. resistance to heat, to moisture, to radiation, to weathering, slow solidification time, good flowability and having good thermal conductivity) that has improved mechanical properties (high modulus and/or elongation at break and/or strength at break) and/or improved thermal properties (low melting temperature and/or improved processing window). Importantly, the material should afford 3D articles with the expected dimensions and shape, and with the desired physico chemical properties. Advantageousy, the non-agglomerated material may be reused for the preparation of other 3D articles.

In this context, the Applicant has solved the above mentioned problem by providing a 3D printable powder comprising:
a polyamide (PA) of the following formula:

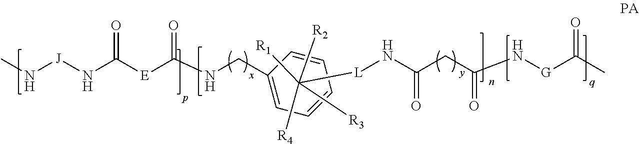

wherein:
   -E- and -J- are identical or different and represent independently from one another a linear or branched, cyclic or acyclic alkylene, or an aromatic bivalent moiety,
   -G- represents a linear or branched, cyclic or acyclic alkylene,
   -L- represents —(CH₂)ₛ with s being an integer ranging from 0 to 6,
   or

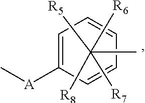

-A- represents —(CH₂)ᵣ— with r being an integer ranging from 1 to 6, a cyclohexylene group, —C(CH₃)₂—, —C(CF₃)₂—, —O—, —O—(CH₂)_{z}—O— with z being an integer ranging from 2 to 12 and preferably z=2, 3, 5, 6 or 12, —O—(CH₂)₂—O—(CH₂)₂—O—(CH₂)₂—O—, —O-Ph-O—, —S—, —S—S—, —S—(CH₂)₃—S—, —CO— or —SO₂—,
—R1, —R2, —R3, —R4, —R5, —R6, —R7 and —R8 are identical or different and represent independently from one another —H, a (C1-C6) alkyl group, —Cl, —Br, or —I,
x is an integer ranging from 0 to 6,
y is an integer ranging from 2 to 11,
n+p+q=1, and
n≥0.1,
and less than 5 wt % of at least one filler relative to the weight of the 3D printable powder.

Preferably in the context of the invention, p≠0 and q=0, or p=0 and q≠0, or p≠0 and q≠0, i.e. at least one of p and q is different from 0.

The Applicant has surprisingly discovered that these particular polyamides allow achieving surprinsingly good mechanical and thermal properties. Filler(s) may then be used in very low amounts, or may even not be required. Moreover, the non consolidated 3D printable powder may be reused for the preparation of another 3D printed article.

The 3D printable powder according to the invention may further have one or more of the following characteristics:
the polyamide PA is prepared from the following comonomers:
   a diamine of formula I:

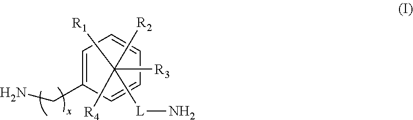

a diacid of formula II:

HOOC—(CH₂)_{y}—COOH (II)
and optionnally at least one additional comonomer III chosen from linear or branched, cyclic or acyclic aliphatic, or aromatic diacids or diamines, or aliphatic aminoacids;
the diamine I is chosen from m-phenylenediamine, p-phenylenediamine, p-xylylenediamine, m-xylylenediamine, 3,4′-diaminodiphenyl ether, 4,4′-diaminodiphenyl ether, 4, 4′-diaminodiphenyl sulfone, 3,3′-diaminophenyl sulfone, 4,4′-diaminodiphenyl sulphide, 4-aminophenyldisulfide, 4,4′-diaminobenzophenone, 4,4′-(ethane-1,2-diylbis(oxy))dianiline, 4,4′-(trimethylenedioxy)dianilie, 4,4′-(tetramethylenedioxy)dianiline, 4,4′-(pentamethylenedioxy)dianiline, 4,4′-(hexamethylenedioxy)dianiline, 4,4′-dodecanediyldioxy-di-aniline, 2,2′-[1,2-ethanediylbis(oxy-2,1-ethanediyloxy)]dianiline, 3,3′-[1,4-phenylenebis(oxy)]dianiline, 2,2′-(1,3-propanediyldisulfanediyl)dianiline, 4,4′-diaminodiphenylmethane, 4,4′-diaminodiphenylethane, 4,4′-(propane-2,2,diyl)dianiline, 4,4′-cyclohexylidene dianiline, and 4,4′-(hexafluoroisopropylidene)dianiline;
the diacid II is chosen from sebacic acid, adipic acid and dodecandioic acid;
the polyamide PA is prepared only from diamine I and diacid II as comonomers;
the polyamide PA is prepared from diamine I, diacid II and from 1 to 90 mol % of at least one additional comonomer III;
the at least one additional comonomer III is chosen from a diamine such as hexamethylene diamine, trimethylhexamethylene diamine, 4,4′-diaminodicyclohexylmethane, 1,3-bis(aminomethyl)cyclohexane, 1,2-diaminocyclohexane, isophorone diamine and decane diamine; a diacid such as hexanoic diacid, nonanoic diacid, decanoic diacid, and dodecanoic diacid; and an aminoacid such as aminohexanoic acid, 11-aminoundecanoic acid and 13-aminotridecanoic acid;
the polyamide PA has an average molecular weight by number Mn of at least 10 000 g·mol⁻¹, preferably of at least 15 000 g·mol⁻¹, and even more preferably of at least 17 500 g·mol⁻¹;
the 3D printable powder comprises less than 2 wt % of filler(s) relative to the weight of the 3D printable powder, preferably less than 1 wt %, and even more preferably the 3D printable powder is substantially free of filler;
the 3D printable powder futher comprises additives, preferably chosen from flow aid(s), retarding agent(s), impact modifier(s), antioxidant(s), co-crystallizer(s), plasticizer(s), dye(s), thermal stabilizer(s), antistatic agent(s), waxe(s), anti-nucleating agent(s) and/or compatibilizer(s).

The invention further relates to the process of preparation of the 3D printable powder according to the invention. In the context of the invention, the 3D printable powder is prepared by polycondensation and a step of mixing with the at least one filler if present.

The process for preparing the 3D printable powder according to the invention may have one or more of the following characteristics:
the process for preparing the polyamide PA is carried out in a reactor and comprises the following steps:
   i) formation of a salt A from diamine I, diacid II and optional additional comonomer(s) III,
   ii) heating of the salt A under pressure,
   iii) removal of the water;
the process for preparing the polyamide PA comprises the following steps:
   a) introduction of diamine I, diacid II and optional additional comonomer(s) III into an extruder including at least two conveying screws rotating co-rotatively,
   b) mixing the comonomers,
   c) polycondensing the comonomers by successively carrying out shearing and depressurization operations on the material conveyed by the conveying screws,
   d) forming a plug of material continuously renewed by conveyance of the material on the conveying screws, between the mixing and polycondensation steps; said material plug consisting of the advancing material filling the whole space available for the passage of the material and forming an area which is hermetic to vapors, and notably to monomer vapors which may be generated;
the process for preparing the polyamide PA comprises the following steps:
   a′) introduction of a polymer (P) into an extruder including at least two conveying screws rotating co-rotatively, said polymer (P) being a homopolymer or copolymer of diamine (I) and/or diacid (II) and/or optional additional comonomer(s) (III),
   b′) introduction of at least one comonomer selected from diamine (I), diacid (II) and optional additional comonomer(s) (III) into said extruder,
   c′) mixing the polymer (P) and the at least one conomoner,
   d′) polycondensing the polymer (P) and the comonomer(s) by successively carrying out shearing and depressurization operations on the material conveyed by the conveying screws,
   e′) forming a plug of material continuously renewed by conveyance of the material on the conveying screws, between the mixing and polycondensation steps; said material plug consisting of the advancing material filling the whole space available for the passage of the material and forming an area which is hermetic to vapors, and notably to monomer vapors which may be generated.

The invention also relates to a 3D printed article made from the 3D printable powder according to the invention, or from the 3D printable powder obtained thanks to the process according to the invention. In the context of the invention, the 3D printed article has advantageously a Young modulus of at least 2000 MPa measured according to NF EN ISO 527-2 and ASTM D638-08 standards. In the context of the invention, the 3D article has advantageously a strength at break of at least 45 MPa measured according to NF EN ISO 527-2 and ASTM D638-08 standards, and preferably of at least 60 MPa

Furthermore, the invention relates to a method for preparing a 3D printed article according to the invention using an additive process, preferably a powder bed fusion process such as selective laser sintering or multi-jet fusion technique.

Finally, the invention relates to the use of a 3D printable powder according to the invention or of a 3D printable powder obtained thanks to the process according to the invention for the manufacture of a 3D printed article.

3D Printable Powder

In the context of the invention, a “3D printable powder” is a powder or pulverulent solid that is usable in a 3D printing process, such as selective laser sintering (SLS) or multi-jet fusion (MJF) technique. Therefore, a 3D printable powder preferably has specific characteristics in order to be used in such process, such as specific melt flow index, thermal properties and granulometry as detailed below.

In order to be used in an additive process, 3D printable powders preferably have a melt flow index ranging from 1 g/10 min to 40 g/10 min, more preferably from 3 g/10 min to 30 g/10 min, even more preferably ranging from 5 g/10 min to 15 g/10 min, at a temperature T_{mf} and under a load of 2.16 kg. The melt flow index is determined according to ISO 1133:2011 standard which indicates the value of T_{mf} depending on the polymer(s) present in the 3D printable powder.

In order to be successfully used in an additive process, a 3D printable powder preferably has specific thermal properties. Advantageously, its melting peak temperature Tₘ is at least 20° C. higher than its crystallization peak temperature T_{c}. Advantageously, its melting peak temperature Tₘ is at most 10° C. higher than its onset melting temperature T_{m onset}. Advantageously, its start melt temperature T_{m start} is at least higher than the onset crystallization temperature T_{c onset}. The melting peak temperature Tₘ, the crystallization peak temperature T_{c}, the onset melting temperature T_{m onset}, and the start melt temperature T_{m start} may be determined by differential scanning calorimetry (DSC) usually at ±10° C./min.

The melting peak temperature Tₘ corresponds to the temperature measured at the maximum of the peak of the thermal phenomenon corresponding to melting. The start melt temperature T_{m start} corresponds to the start of the phenomenon of melting of the crystallites, i.e. when the first crystallites start to melt. The onset value corresponds to an extrapolated temperature corresponding to the intersection of the base line of the peak and of the tangent to the point with the largest slope of the first portion of the melting peak for temperatures below the maximum temperature for the peak. The onset of crystallization is determined with the same graphical method during the cooling phase. The crystallization peak temperature corresponds to the temperature measured at the maximum of the peak of the thermal phenomenon corresponding to crystallization.

In order to be used in an additive process, a 3D printable powder preferably has a melting peak temperature Tₘ from about 70° C. to about 250° C., preferably from about 110° C. to about 200° C.

In order to be used in an additive process, the processing window (i.e. the gap between the onset of the crystallisation peak and the onset of the melting peak) is advantageously of at least 10° C.

In order to be used in an additive process, a 3D printable powder advantageously has:
a mean particle size d10 ranging from 20 μm to 60 μm,
a mean particle size d50 ranging from 40 μm to 130 μm, and
a mean particle size d90 ranging from 75 μm to 200 μm.

The mean particle sizes d10, d50, d90 and d99 are the mean sizes of particles (corresponding to the highest dimension of said particles) for which 10%, 50%, 90% and 99% by volume respectively of said particles have a lower size, as measured by dry laser granulometry technique (also known as laser diffraction granulometry). When the particle is spherical, the mean particle size d50 corresponds to the mean particle diameter d50.

According to the invention, the 3D printable powder comprises at least one polyamide, and less than 5 wt % of at least one filler relative to the weight of the 3D printable powder.

According to the invention, the polyamide PA has the following formula:

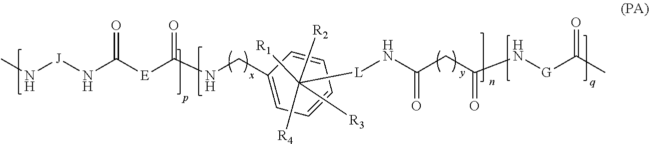

wherein:
-E- and -J- are identical or different and represent independently from one another a linear or branched, cyclic or acyclic alkylene, or an aromatic bivalent moiety,
-G- represents a linear or branched, cyclic or acyclic alkylene,
-L- represents —(CH₂)ₛ with s being an integer ranging from 0 to 6, or

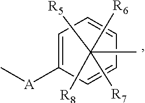

-A- represents —(CH₂)ᵣ— with r being an integer ranging from 1 to 6, a cyclohexylene group, —C(CH₃)₂—, —C(CF₃)₂—, —O—, —O—(CH₂)_{z}—O— with z being an integer ranging from 2 to 12 and preferably z=2, 3, 5, 6 or 12, —O—(CH₂)₂—O—(CH₂)₂—O—(CH₂)₂—O—, —O-Ph-O—, —S—, —S—S—, —S—(CH₂)₃—S—, —CO— or —SO₂—,
—R1, —R2, —R3, —R4, —R5, —R6, —R7 and —R8 are identical or different and represent independently from one another —H, a (C1-C6) alkyl group, —Cl, —Br, or —I,
x is an integer ranging from 0 to 6,
y is an integer ranging from 2 to 11,
n+p+q=1, and
n≥0.1.

In the context of the invention, an “alkylene” group is a divalent alkyl group.

In the context of the invention, a “cyclohexylene” group is a divalent cyclohexyl group. The two bonds of the cyclohexylene group may be in 1,2, 1,3 or 1,4 position.

Polyamide PA is preferably a random copolymer when p and/or q are different from 0. In other words, polyamide PA is preferably a random copolymer when p≠0 and q=0 or p=0 and q≠0 or p≠0 and q≠0.

-E-, -G- and -J- may be identical or different.

When -E- and/or -G- and/or -J- represent linear or branched, cyclic or acyclic alkylene group, they are preferably chosen from C2-C36 alkylene, preferably C4-C18 alkylene, even more preferably C6-C12 alkylene. According to this embodiment, the alkylene is preferably acyclic, linear or branched. Examples of alkylene groups are hexylene; 1,2-, 1,3- or 1,4-cyclohexylene; trimethylhexamethylene; nonylene; decylene; undecylene; dodecylene; tridecylene; dicyclohexylenemethane; 1,3-cyclohexane bis methylene. Preferred alkylene groups are hexylene, cyclohexylene, trimethylhexamethylene, and dicyclohexylenemethane.

-L- is a linker between the aromatic ring and the amino function. The linker -L- may be in ortho, meta or para position relative to the NH₂—(CH₂)ₓ— group, but is preferably in meta or para position.

Preferably, x and s are identical or different and represent an integer ranging from 0 to 4, more preferably from 0 to 2, and even more preferably x and/or s are equal to 0 or 1. In a preferred embodiment, x=s.

According to a first embodiment, -L- represents —(CH₂)ₛ— with s being as defined above.

According to a second embodiment, -L- represents:

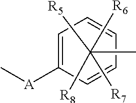

with -A- being in ortho, meta or para position relative to the amino group, preferably in meta or para position. Preferably according to this embodiment, both -L- and -A- are in meta position relative to the amino groups or both -L- and -A- are in para position relative to the amino groups. According to this embodiment, -A- preferably represents —(CH₂)ᵣ with r as defined above, —O—, —CO—, —SO₂— or —C(CH₃)₂—, and more preferably —CH₂—, —(CH₂)₂—, 1,2-cyclohexylene, 1,3-cyclohexylene or 1-4-cyclohexylene. According to this embodiment, —R5, —R6, —R7 and —R8 are preferably identical. According to this embodiment, —R5, —R6, —R7 and —R8 preferably represent —H, —CH₃, —CH₂CH₃, —Cl, —Br or —I.

Preferably, y is an integer ranging from 4 to 11, preferably from 4 to 8.

According to a first embodiment, p=q=0. In other words, the polyamide PA has the following formula PA′ according to this embodiment:

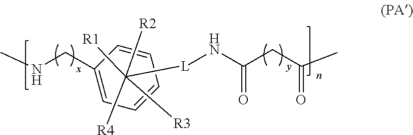

wherein x, y, n, —R1, —R2, —R3, —R4 and -L- are as defined above.

According to a second embodiment, p≠0 and q=0. According to this embodiment, p is of at most 0.9, and ranges advantageously from 0.005 to 0.9, preferably from 0.01 to 0.9, more preferably from 0.2 to 0.8. In a particular embodiment, -J- represents —(CH₂)ₓ-Ph-L- and -E- is not —(CH₂)_{y}—. According to another particular embodiment, -E- represents —(CH₂)_{y}— and -J- is not —(CH₂)ₓ-Ph-L-.

According to a third embodiment, p=0 and q≠0. According to this embodiment, q is of at most 0.9, and ranges advantageously from 0.005 to 0.9, preferably from 0.01 to 0.9, more preferably from 0.2 to 0.7.

According to a fourth embodiment, p≠0 and q≠0. According to this embodiment, p+q≤0.9, and p+q ranges advantageously from 0.005 to 0.9, preferably from 0.01 to 0.9, more preferably from 0.2 to 0.7. In a particular embodiment, -J- represents —(CH₂)ₓ-Ph-L- and -E- is not —(CH₂)_{y}—. According to another particular embodiment, -E- represents —(CH₂)_{y}— and -J- is not —(CH₂)ₓ-Ph-L-.

Preferably in the context of the invention, p≠0 and q=0, or p=0 and q≠0, or p≠0 and q≠0. Even more preferably:
p≠0, p≤0.9, and q=0, or
p=0, q≠0, and q≤50.9, or
p≠0, q≠0 and p+q≤0.9.

According to a preferred embodiment, -L- represents —(CH₂)ₛ— and x and s are identical or different and each represent an integer ranging from 0 to 4, more preferably 0 to 2, and even more preferably equals to 0 or 1.

According to another preferred embodiment, x is an integer ranging from 0 to 4, more preferably 0 to 2, and even more preferably equals to 0 or 1, and -L- represents —(CH₂)ᵣ-Ph- (with the amino group preferably in meta or para position) with r as defined above.

According to another preferred embodiment, x is an integer ranging from 0 to 4, more preferably 0 to 2, and even more preferably equals to 0 or 1, and -L- represents —O-Ph-, —COPh-, SO₂-Ph- or —C(CH₃)₂-Ph (with the amino group preferably in meta or para position).

According to another preferred embodiment, -L- represents —(CH₂)ₛ— and x and s are identical or different and each represent an integer ranging from 0 to 4, more preferably 0 to 2, and even more preferably equals to 0 or 1, and y is an integer ranging from 4 to 8.

According to another preferred embodiment, x is an integer ranging from 0 to 4, more preferably 0 to 2, and even more preferably equals to 0 or 1, y is an integer ranging from 4 to 8 and -L- represents —(CH₂)ᵣ-Ph- (with the amino group preferably in meta or para position) with r as defined above.

According to another preferred embodiment, x is an integer ranging from 0 to 4, more preferably 0 to 2, and even more preferably equals to 0 or 1, y is an integer ranging from 4 to 8 and -L- represents —O-Ph-, —COPh-, SO₂-Ph- or —C(CH₃)₂-Ph (with the amino group preferably in meta or para position).

The polyamide PA according to the invention is prepared from a diamine I, a diacid II and optional additional comonomer(s) III.

According to the invention, the diamine I is of the following formula wherein x, —R1, —R2, —R3, —R4 and -L- are as defined above:

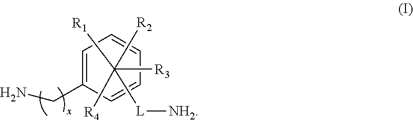

Preferably, the diamine I is chosen from m-phenylenediamine, p-phenylenediamine, p-xylylenediamine, m-xylylenediamine, 3,4′-diaminodiphenyl ether, 4,4′-diaminodiphenyl ether, 4, 4′-diaminodiphenyl sulfone, 3,3′-diaminophenyl sulfone, 4,4′-diaminodiphenyl sulphide, 4-aminophenyldisulfide, 4,4′-diaminobenzophenone, 4,4′-(ethane-1,2-diylbis(oxy))dianiline, 4,4′-(trimethylenedioxy)dianiline, 4,4′-(tetramethylenedioxy)dianiline, 4,4′-(pentamethylenedioxy)dianiline, 4,4′-(hexamethylenedioxy)dianiline, 4,4′-dodecanediyldioxy-di-aniline, 2,2′-[1,2-ethanediylbis(oxy-2,1-ethanediyloxy)]dianiline, 3,3′-[1,4-phenylenebis(oxy)]dianiline, 2,2′-(1,3-propanediyldisulfanediyl)dianiline, 4,4′-diaminodiphenylmethane, 4,4′-diaminodiphenylethane, 4,4′-(propane-2,2,diyl)dianiline, 4,4′-cyclohexylidene dianiline, and 4,4′-(hexafluoroisopropylidene)dianiline. Particularly preferred diamine I are m-phenylenediamine, p-phenylenediamine, p-xylylenediamine, m-xylylenediamine, 3,4′-diaminodiphenyl ether, 4,4′-diaminodiphenyl ether, 4, 4′-diaminodiphenyl sulfone, 3,3′-diaminophenyl sulfone, 4,4′-diaminodiphenyl sulphide, and 4,4′-diaminodiphenylmethane, and in particular m-xylylenediamine.

According to the invention, the diacid II is of formula HOOC—(CH₂)_{y}—COOH, with y being as defined above.

According to a preferred embodiment, the diacid II is chosen from sebacic acid, adipic acid and dodecandioic acid, and is preferably sebacic acid.

In the context of the invention, N_{I} represents the number of moles of diamine I, N_{II} represents the number of moles of diacid II, and N_{III}, represents the number of moles of comonomer III, or the total number of moles of comonomers III when more than one comonomer III are used. Comonomer(s) III can be chosen from linear or branched, cyclic or acyclic aliphatic, or aromatic diacid(s) or diamine(s) or aliphatic aminoacid(s) or a mixture thereof. When more than on comonomer III are present, N_{III}=N_{IIIdiacid}+N_{IIIdiamine}+N_{IIIaminoacid} where N_{III diacid} represents the total number of moles of linear or branched, cyclic or acyclic aliphatic, or aromatic diacid(s) used as comonomer III, N_{III diamine} represents the total number of moles of linear or branched, cyclic or acyclic aliphatic, or aromatic diamine(s) used as comonomer III and N_{III aminoacid} represents the total number of moles of aminocids used as comonomer III.

According to a first embodiment, the polyamide PA is prepared using only the diamine I and the diacid II as defined above as comonomers (in other words, N_{III}, =0). According to this embodiment, the polyamide PA is prepared from molar ratio of diamine I:diacid II (i.e. the ratio N_{I}/N_{II}) ranging from 1:1 to 1.1:1, preferably from 1:1 to 1.05:1.

According to this embodiment, the polyamide PA may be for example prepared from m-xylylenediamine and sebacic acid.

According to a second embodiment, the polyamide PA is prepared using at least one additional comonomer III, and in particular one, two or three. According to this embodiment, the at least one additional comonomer III is present in an amount ranging from 0.5 to 90 mol %, preferably from 1 to 90 mol % relative to the total amount of comonomers (i.e. diamine I, diacid II and comonomer(s) III). In other words, according to this embodiment, the molar ratio of amine functions:acid functions (i.e the ratio (2*N_{I}+2*N_{III diamine}+N_{III aminoacid})/(2*N_{II}+2*N_{III diacid}+N_{III aminoacid})) ranges from 1:1 to 1.1:1, preferably from 1:1 to 1.05:1 and the ratio N_{III}/(N_{I}+N_{II}+N_{III}) ranges from 0.01 to 0.9.

According to this embodiment, the at least one additional comonomer III is an aliphatic aminoacid present in an amount ranging from 1 to 90 mol % relative to the total amount of comonomers, or is a from 1:1 to 1.1:1, preferably from 1:1 to 1.05:1 molar ratio of linear or branched, cyclic or acyclic aliphatic, or aromatic diamine(s) and linear or branched, cyclic or acyclic aliphatic, or aromatic diacid(s) each present in an amount ranging from 0.5 to 45 mol % relative to the total amount of comonomers. In other words, according to this embodiment:
(2*N_{I}+N_{III aminoacid})/(2*N_{II}+N_{III aminoacid}) ranges from 1:1 to 1.1:1, preferably from 1:1 to 1.05:1 and N_{III aminoacid}/(N_{I}+N_{II}+N_{III aminoacid}) ranges from 0.01 to 0.9 when the at least one additional comonomer III is an aliphatic aminoacid, or
the ratio (N_{I}+N_{III diamine})/(N_{II}+N_{II diacid}) ranges from 1:1 to 1.1:1, preferably from 1:1 to 1.05:1, and N_{III diacid}/(N_{I}+N_{II}+N_{III}) and N_{II diamine}/(N_{I}+N_{II}+N_{III}) are both ranging from 0.005 to 0.45 when a mixture of linear or branched, cyclic or acyclic aliphatic, or aromatic diacids and of linear or branched, cyclic or acyclic aliphatic, or aromatic diamines is used as comonomers III.

Examples of comonomers III that may be used in the context of the invention are:
linear or branched, cyclic or acyclic aliphatic, or aromatic diamines: hexamethylene diamine, trimethylhexamethylene diamine, 4,4′-diaminodicyclohexylmethane, 1,3-bis(aminomethyl)cyclohexane, 1,2-diaminocyclohexane, isophorone diamine, 1,8-nonane diamine, 1,5-nonane diamine and decane diamine,
linear or branched, cyclic or acyclic aliphatic, or aromatic diacids: hexanoic diacid, heptanoic diacid, octanoic diacid, nonanoic diacid, decanoic diacid, undecanoic diacid, dodecanoic diacid and tridecanoic diacid,
linear or branched, cyclic or acyclic aliphatic aminoacids: aminohexanoic acid, 11-aminoundecanoic acid, 12-amino lauric acid and 13-aminotridecanoic acid.

When at least one comonomer III is present, the polyamide PA may be for example prepared from:
m-xylylenediamine, sebacic acid, and hexamethylene diamine, or
m-xylylenediamine, sebacic acid, and trimethylhexamethylene diamine.

Advantageously, the polyamide PA has an average molecular weight by number Mn of at least 10 000 g·mol⁻¹, preferably of at least 15 000 g·mol⁻¹, and even more preferably of at least 17 500 g·mol⁻¹. Molecular weight by number can be determined by HFIP-GPC.

Advantageously, the polyamide PA has a melt viscosity rate (MVR) lower than 100 cm³/10 minutes measured with a melt flow indexer at 240° C. under 2.14 kg, preferably lower than 40 cm³/10 minutes, and even more preferably lower than 25 cm³/10 minutes.

Advantageously, the polyamide PA has an onset melting temperature ranging from 120° C. to 215° C., preferably from 150° C. to 185° C.

Advantageously, the polyamide PA has a melting peak temperature ranging from 130° C. to 230° C., preferably from 180° C. to 210° C.

Advantageously, the polyamide PA has an onset crystallization temperature ranging from 100° C. to 190° C., preferably from 135° C. to 170° C.

Advantageously, the polyamide PA has a crystallization peak temperature ranging from 110° C. to 180° C., preferably from 120° C. to 155° C.

The 3D printable composition according to the invention may further comprise at least one filler in an amount of less than 5 wt % relative to the weight of the 3D printable compostion, preferably less than 2 wt %, more preferably less than 1 wt %, and even more preferably the 3D printable powder is substantially free of filler. In the context of the invention, “substantially free of filler” means that less than 0.1 wt % of filler(s) relative to the weight of the 3D printable composition is present, and preferably no filler is present.

Examples of fillers that may be used in the context of the invention are natural or synthetic inorganic fillers such as glass beads, fumed silica, hollow glass beads, glass fibers, crushed glass, silicone dioxide, aluminum oxide, calcium carbonate, kaolin (hydrous aluminum silicate), and combinations thereof, ceramic fillers such ceramic fibers, silicon carbide fibers, alumina fiber, and combinations thereof, natural or synthetic organic fillers such as carbon fibers, polyamide fibers, polytetrafluoroethylene fibers, liquid crystal (LCP) fibers, Kevlar® fibers, and combinations thereof, inorganic oxides, carbides, borides and nitrides such as inorganic oxides, nitrides, borides and carbides of zirconium, tantalum, titanium, tungsten, boron, aluminum and beryllium, silicon carbide and aluminum oxide.

The 3D printable composition may further comprise additives, such as flow aid(s), flame retarding agent(s), impact modifier(s), antioxidant(s), co-crystallizer(s), plasticizer(s), dye(s), thermal stabilizer(s), antistatic agent(s), waxe(s), anti-nucleating agent(s), and/or compatibilizer(s). The amount of these additives if present ranges preferably from 0.01 wt % to 25 wt % relative to the weight of the 3D printable composition.

Particularly preferred additives are flow aids. When flow aid(s) are present, the amount of flow aid(s) ranges preferably from 0.2 wt % to 1 wt % relative to the weight of the 3D printable composition, more preferably from 0.2 wt % to 0.5 wt %. In the context of the invention, the flow aid(s) are in solid form, e.g. as a powder. Preferably, the flow aid(s) are present as nano or micro particles.

In the context of the invention, “nanoparticles” refer to particles of nanometric elementary size, i.e. of elementary size of at least 1 nm and no more than 100 nm. By “elementary size”, it is meant the highest dimension of the nanoparticle.

In the context of the invention, “microparticles” refer to particles of micrometric elementary size, i.e. of elementary size of at least 1 μm and no more than 100 μm.

Polar or apolar flow aids may be used in the context of the invention. Example of flow aids that may be used in the context of the invention are apolar or polar silica such as micrometric colloidal silica or nanometric fumed silica; alumina such as micro or nano spheric particles of alumina; and waxes presenting a melting temperature of at least the melting temperature of the polyamide minus 10° C. such as long chain carboxylic acid amide, long chain carboxylic acid ester and long chain cationic carboxylate.

Commercially available flow aids that may be used in the context of the invention are Gasil® 23F, Gasil®GM2, Gasil® IJ1 and Gasil®HP210 from PQ Corporation; SIPERNAT® 22S and SIPERNAT® 50 from Evonik Resources Efficiency GmbH; HDK® H20 and HDK® N20 from Wacker; AEROXIDE® OX50, AEROXIDE® ALU C, AEROSIL® COK84, AEROSIL® 200, AEROSIL® R812 and AEROSIL® R974 from Evonik Resources Efficiency GmbH; SPECTRAL®81, SPECTRAL®100 and CAB-O-SIL® M5 from Cabot Corporation.

Flame retarding agents may be cited as particular additives. When flame retarding agent(s) is present in the 3D printable powder, it may be selected from the group consisting of an alkali or earth alkali sulfonate, sulphonamide salt, perfluoroborate, halogenated compound, polyphosphoric acid, phosphorus pentoxide, organic polyphosphonates and phosphorus-bearing organic compound, and combinations thereof. Advantageously, non-halogenated flame retarding agents are preferred.

In a particular embodiment, inorganic flame retarding agent(s) may be present as additives, eventually in combination with organic flame retarding agent(s). According to this embodiment, less than 5 wt % of inorganic flame retarding agents are present in the 3D printable composition according to the invention, preferably less than 2 wt %, and even more preferably less than 1 wt %.

In the context of the invention, the impact modifier may be an elastomer.

As examples of thermal stabilizer, one may cite hindered phenols, hindered amines, phosphoric compounds, copper choride, and halide salts.

The 3D printable composition according to the invention has advantageously a sintering window of 30° C. to 40° C.

The 3D printable composition according to the invention preferably has a mean particle size d10 ranging from 24 μm to 50 μm, preferably from 30 μm to 45 μm.

The 3D printable composition according to the invention preferably has a mean particle size d50 ranging from 50 μm to 80 μm, preferably from 54 μm to 75 μm.

The 3D printable composition according to the invention preferably has a mean particle size d90 ranging from 75 μm to 130 μm, more preferably from 75 μm to 100 μm, even more preferably from 75 μm to 90 μm.

The 3D printable composition according to the invention preferably has a mean particle size d99 of at most 160 μm, preferably lower than 150 μm.

Process of Preparation of the 3D Printable Composition

The invention further relates to the process of preparation of the 3D printable powder according to the invention.

The 3D printable powder is prepared by mixing the polyamide PA with the at least one filler, if the at least one filler is present, during the polycondensation reaction, or after the polycondensation reaction.

In the context of the invention, the polyamide PA is prepared by polycondensation from a diamine I, a diacid II and eventually one or more additional comonomer(s) III. This means that diamine I, diacid II and optional additional comonomer(s) III are contacted and mixed together in order to react together, or that one or more of these comonomers is first reacted to form a homo- or copolymer that is then contacted and mixed with the other comonomer(s) in order to react together.

According to a first embodiment, the polyamide PA is reacted in a reactor. According to this embodiment, the polyamide PA is prepared according to the following successive steps:
i) formation of a salt A from diamine I, diacid II and optional additional comonomer(s) III,
ii) heating of the salt A under pressure,
iii) removal of the water.

During step i) the salt A may be formed by contacting and mixing the comonomers (i.e. diamine I, diacid II and optional additional comonomer(s) III). For that purpose, the comonomers may be introduced in a vessel simultaneously or one after the other in any order and then mixed. This may be performed by dissolving the comonomers in an aqueous solution.

During step ii), salt A is heated in order to promote the polycondensation reaction. Preferably, this step is carried out under inert atmosphere. For example, temperatures in the range of 240° C. to 280° C. and pressures of 0.01 to 0.1 mL of mercury may be applied.

During the polycondensation reaction, water is produced. In order to promote the polycondensation reaction, water is removed from the reaction mixture. The removal of the water during step iii) may be performed by any means known from one skilled in the art, such as for example heating in order to evaporate the water.

According to another embodiment, the polyamide PA is prepared by polycondensing diamine I, diacid II and optional additional comonomer(s) III in an extruder, preferably a twin screw extruder. According to this embodiment, the process of preparation of the polyamine comprises the following successive steps:
a) introduction of diamine I, diacid II and optional additional comonomer(s) III into an extruder including at least two conveying screws rotating co-rotatively,
b) mixing the comonomers (i.e. diamine I, diacid II and optional additional comonomer(s) III),
c) polycondensing the comonomers by successively carrying out shearing and depressurization operations on the material conveyed by the conveying screws,
d) forming a plug of material continuously renewed by conveyance of the material on the conveying screws, between the mixing and polycondensation steps; said material plug consisting of the advancing material filling the whole space available for the passage of the material and forming an area which is hermetic to vapors, and notably to monomer vapors which may be generated.

The process for the preparation of the polyamide PA according to this embodiment has been previously described in patent application WO 2014/016521.

Alternatively, the polyamide PA may be prepared by polycondensing diamine I and/or diacid II and/or optional additional comonomer(s) III with a homo- or copolymer of one or more of these comonomers in an extruder, preferably a twin screw extruder. According to this embodiment, the process of preparation of the polyamine comprises the following successive steps:
a′) introduction of a polymer P into an extruder including at least two conveying screws rotating co-rotatively, said polymer P being a homopolymer or copolymer of diamine I and/or diacid II and/or optional additional comonomer(s) III,
b′) introduction of at least one comonomer selected from diamine I, diacid II and optional additional comonomer(s) III into said extruder,
c′) mixing the polymer P and the at least one conomoner,
d′) polycondensing the polymer (P) and the comonomer(s) by successively carrying out shearing and depressurization operations on the material conveyed by the conveying screws,
e′) forming a plug of material continuously renewed by conveyance of the material on the conveying screws, between the mixing and polycondensation steps; said material plug consisting of the advancing material filling the whole space available for the passage of the material and forming an area which is hermetic to vapors, and notably to monomer vapors which may be generated.

According to this embodiment, the polyamide PA may be prepared according to the process described in patent application WO 2014/016521.

Whatever the process used to perfom the polycondensation, a catalyst may be used. Catalysts commonly used and known from one skilled in the art may be used in the context of the invention.

Whatever the process used for the preparation of the polyamide PA, the polyamide is then preferably powdered using any method known from one skilled in the art, such as cryo-milling or solvent precipitation.

Finally, when filler(s) and/or additive(s) are present, they may be added at single or at different stages of the process, simultaneously or one after the other in any order:
addition during the preparation of the polyamide PA, i.e. during the polycondensation reaction,
addition after de preparation of the polyamide PA and before the powdering step. This may be performed in an extruder,
addition to the powdered polyamide PA.

Three Dimensional Printed Article and Method of Preparation

The invention further relates to a 3D printed article made from the 3D printable powder as defined above, or from the 3D printable powder obtained from the process described above.

In the context of the invention, a “3D printed article” (or “three dimensional printed article” or “3D article”) refers to an object bluit by a 3D printing system, such as SLS or MJF for example.

According to the invention, the 3D printed article preferably has a Young modulus of at least 2 GPa, preferably ranging from 3.6 to 3.8 GPa. In the context of the invention, the Young modulus may be measured according to NF EN ISO 527-2 and ASTM D638-08 standards. Advantageously according to this invention, this high Young modulus value is maintained even after water exposition or humid conditions.

The 3D printed article preferably has a strength at break of at least 45 MPa, preferably of at least 60 MPa, and more preferably ranging from 65 to 80 MPa. In a particular embodiment, a printed article prepared from a polyamide PA such that p=q=0 (i.e. when the polyamide PA is synthetised without comonomer III) has preferably a strength at break of at least 60 MPa. In another particular embodiment, a printed article prepared from a polyamide PA such that p≠0 and/or q≠0 (i.e. when the polyamide PA is synthetised with at least one comonomer III) has preferably a strength at break of at least 45 MPa. In the context of the invention, the strength at break may be measured according to NF EN ISO 527-2 and ASTM D638-08 standards.

Finally, the invention relates to a method for preparing a 3D printed article. Several additive methods may be used, among which selective laser sintering (SLS) and multi-jet fusion (MJF) techniques are particularly preferred.

The SLS technique implies the formation of superimposed layers that are bonded together by repeating the following two steps:
a) depositing a continuous bed of 3D printable powder or exclusively constituted by the 3D printable powder as defined in the context of the invention, on a platform or on a previously consolidated layer;
b) carrying out a localized consolidation of a portion of the deposited 3D printable powder by applying a laser beam in accordance with a predetermined pattern for each layer and simultaneously bonding the layer that has been formed thereby to the preceding consolidated layer if present, in a manner such as to cause the desired three-dimensional shape of the 3D article to grow progressively.

Advantageously, the continuous bed of 3D printable powder of step a) has a constant thickness and extends as a surface above the section of the desired 3D article taken at the level of the layer, in order to guarantee precision at the ends of the article. The thickness of the bed of powder is advantageously in the range of 40 μm to 120 μm.

The consolidation of step b) is carried out by laser treatment. To this end, it is possible to use any SLS printing machine that is known to the person skilled in the art such as for example a 3D printer of the SnowWhite type from Sharebot, of the Vanguard HS type from 3D Systems, of the Formiga P396 type from EOS, of the Promaker P1000 type from Prodways, of Formiga P110 type from EOS or of HT251P type from Farsoon.

The parameters of the SLS printing machine are selected in a manner such that the surface temperature of the bed of powder composition is in the sintering range, i.e. comprised between the offset crystallization temperature and the onset fusion temperature. For example, the process temperature ranges between 140° C. to 200° C., preferably from 152° C. to 182° C., more preferably from 162° C. to 177° C.

The MJF technique implies the formation of superimposed layers that are bonded together by repeating the following steps:
a) depositing a continuous bed of 3D printable powder comprising or exclusively constituted by the 3D printable powder as defined in the context of the invention, on a platform or on a previously consolidated layer;
b) applying a fusing agent in accordance with a predetermined pattern for each layer,
c) carrying out a localized consolidation of a portion of the deposited 3D printable powder by application of energy.

The MJF process may also comprise the application of a detailing agent.

Fusing agents and detailing agents that may be used according to the invention are those commonly used in the art, as detailed in patent application WO 2019/182579 for example.

Whatever the additive process used, the 3D printable powder may be recycled. In other words, the 3D printable powder used that is not consolidated during the additive process for the preparation of a 3D printed article may be reused for the preparation of another 3D printed article. Typically, 20 wt % to 100 wt % of 3D printable powder is recycled 3D printable powder according to this embodiment. Advantageously according to this embodiment, both mechanical properties of the 3D printed article and sintering thermal properties of the 3D printable powder are same when the 3D printable powder comprise reused non consolidated 3D printable powder or only “fresh” (i.e. not reused) 3D printable powder.

The invention will now be further illustrated by the following examples that are for illustrative purpose only.

### EXAMPLES

In the following examples:
the melt viscosity rates (MVR) are measured with a melt flow indexer at 240° C. under 2.14 kg according to ISO 1133:2011 standard;
the granulometries of the 3D printable powders are measured with a granulometer Mastersizer 3000 from Malvern;
the Hausner ratio and the initial bulk density of the 3D printable powders are determined with a granular material density analyzer (GranuPack from GranuTools™) using a tapped density measurement test;
Young modulus, stress at break, stress at yield, strain at yield and strain at break are measured according to NF EN ISO 527-2 and ASTM D638-08 standards.

### Example 1

Using a 110 L/D (diameter: 32 mm) twin-screw extruder as continuous reactor, m-xylylenediamine (136.19 g·mol⁻¹) and sebacic acid (202.25 g·mol⁻¹) were polymerized using process described in patent application WO 2014/016521 to produce a polyamide PA1 with a MVR of 33 cm³/10 min.

Polyamide PA1 was produced from 22070 g of m-xylylenediamine, 31800 g of sebacic acid and 50.88 g of phosphoric acid (H₃PO₄). No filler or other additive was added to polyamide PA1.

A twenty kilograms sample was grinded using a cryo-milling equipment (Godding and Dressler), mixed with 0.25% Cabosil M5 and sieved (90 μm) to afford a 3D printable powder PP1 according to the invention.

The Hausner ratio of 3D printable powder PP1 is of 1.175 [Ø] with an initial bulk density of 0.462 g·cm³.

Four kg of 3D printable powder PP1 were used to prepare a 3D printed article by laser sintering printing using a Formiga P110 sold by EOS. The laser parameters used were as follows: power at 12 W/14 W, hatching distance at 0.15 mm, speed at 3500 mm·second. The printer parameters were as follows: the chamber temperature was 177° C. and the tank temperature was 150° C.

H1 tensile specimens (ISO 527) were printed and unpacked from the building “cake” with a good dimensional stability (no bending) after the end of printing.

### Example 2

Using a 110 L/D (diameter: 32 mm) twin-screw extruder as continuous reactor, m-xylylenediamine (136.19 g·mol⁻¹) and sebacic acid (202.25 g·mol⁻¹) were polymerized using the process described in patent application WO 2014016521 to produce a polyamide PA2 with a MVR of 25 cm³/10 min.

Polyamide PA2 was produced from 22070 g of m-xylylenediamine, 31800 g of sebacic acid, and 50.88 g of phosphoric acid (H₃PO₄). No filler or other additive was added to polyamide PA2.

A twenty kilograms sample was grinded using a continuous cryo-miller (GSM 250 from Gotic) equipped with a 90 μm sieve. Powdered polyamide PA2 was then mixed with 0.25 wt % of fumed silica (AEROSIL® R812 sold by EVONIK) to afford 3D printable powder PP2.1.

The Hausner ratio of 3D printable powder PP2.1 is of 1.216 [Ø] with an initial bulk density of 0.463 g·cm³.

Four kg of 3D printable powder PP2.1 were used to prepare a 3D printed article by laser sintering printing using a Formiga P110 from EOS. The laser parameters were as follows: power at 12 W/14 W, hatching distance at 0.15 mm, speed at 3500 mm·second. The printer parameters were as follows: chamber temperature at 175° C. and tank temperature at 130° C.

H1 tensile specimen (ISO 527) were printed and unpacked from the building “cake” with a good dimensional stability (no bending) after the end of printing.

Powdered polyamide PA2 was also mixed with 0.5 wt % of another fumed silica (CABOSIL® M5 from Cabot Corporation) to afford 3D printable powder PP2.2.

The Hausner ratio of 3D printable powder PP2.2 is of 1,192 [Ø] and the initial bulk density is of 0.529 g·cm³.

Ten kg of 3D printable powder PP2.2 were used to prepare a 3D printed article by laser sintering using a Prodways Promaker P1000 sold by EOS. The used laser parameters were as follows: power at 14.7 W/12 W, hatching distance at 0.15 mm/0.15 mm, speed at 3500 mm·second. The used printer parameters were as follows: the chamber temperature was 175.5° C. (front) and 177.5° C. (back), the piston temperature was of 150° C., the three heating belts of the chamber were at 140° C. and the feeder temperature was of 80° C.

H1 tensile specimens (ISO 527) were printed and unpacked from the building “cake” with a good dimensional stability (no bending) after the end of printing.

### Example 3

Using a 110 L/D (diameter: 32 mm) twin-screw extruder as continuous reactor, m-xylylenediamine (136.19 g·mol⁻¹) and sebacic acid (202.25 g·mol⁻¹) were polymerized using process described in patent application WO 2014/016521 to produce a polyamide PA3 with a MVR of 25 cm³/10 min.

The polyamide was produced from 22070 g of m-xylylenediamine, 31800 g of sebacic acid and 50.88 g of phospohoric acid (H₃PO₄). No filler or other additive was added to polyamide PA3.

A twenty kilograms sample was grinded using a continuous cryo-miller (GSM 250 from Gotic) equipped with a 90 μm sieve. Powdered polyamide PA3 was mixed with 0.25 wt % of fumed silica (AEROSIL® R812 from EVONIK) and dried at 110° C. under vacuum during 2 hours (final moisture 0.4%) to afford 3D printable powder PP3.

The Hausner ratio of 3D printable powder PP3 is of 1.23 [Ø] with an initial bulk density of 0.44 g·cm³.

Five kg of 3D printable powder PP3 were used to prepare a 3Dprinted article by laser sintering printing using a Formiga P110 from EOS. The laser parameters were as follows: power at 12 W/14 W, hatching distance at 0.15 mm, speed at 3500 mm·second. The printer parameters were as follows: chamber temperature at 175° C. and tank temperature at 130° C.

H1 tensile specimens (ISO 527) were printed and unpacked from the building “cake” with a good dimensional stability (no bending) after the end of printing.

### Example 4

Using a 110 L/D (diameter: 32 mm) twin-screw extruder as continuous reactor, m-xylylenediamine (136.19 g·mol-1), hexamethylene diamine (116.21 g·mol-1) and sebacic acid (202.25 g·mol⁻¹) were polymerized using the process described in patent application WO 2014/016521 to produce a polyamide PA4 with a MVR of 37 cm³/10 min.

Polyamide PA4 was produced from 13555 g of m-xylylenediamine, 1285 g of hexamethylene diamine, 20450 g of sebacic acid and 32.72 g of phosphoric acid. Hexamethylene diamine represents 10% (mol/mol) of diamine content. No filler or other additive was added to polyamide PA4.

A twenty kilograms sample is grinded a continuous cryo-miller (GSM 250 from Gotic) equipped with a 90 μm sieve. Powdered polyamide PA4 was then mixed with 0.25 wt % of fumed silica (AEROSIL® R812 sold by EVONIK) to afford 3D printable powder PP4.

The Hausner ratio of 3D printable powder PP4 is of 1.299 [Ø] with an initial bulk density of 0.488 g·cm³.

Four kg of 3D printable powder PP4 were used to prepare a 3D printed article by laser sintering printing using a Formiga P110 from EOS. The laser parameters were as follows: power at 12 W/14 W, hatching distance at 0.15 mm, speed at 3500 mm·second. The printer parameters were as follows: chamber temperature at 173° C. and tank temperature at 130° C.

H1 tensile specimens (ISO 527) were printed and unpacked from the building “cake” with a good dimensional stability (no bending) after the end of printing.

### Example 5

Using a 110 L/D (diameter: 32 mm) twin-screw extruder as continuous reactor, m-xylylenediamine (136.19 g·mol⁻¹), trimethylhexamethylene diamine (158.28 g·mol⁻¹) and sebacic acid (202.25 g·mol⁻¹) were polymerized using process described in patent application WO 2014/016521 to produce a polyamide PA5 with a MVR of 15 cm³/10 minutes.

Polyamide PA5 was produced from 14394 g of m-xylylenediamine, 880 g of trimethylhexamethylene diamine, 20450 g of sebacic acid and 32.72 g of phosphoric acid (H₃PO₄). Trimethylhexamethylene diamine represents 5% (mol/mol) of the diamine content. No filler or other additive was added to polyamide PA5.

A twenty kilograms sample was grinded using a continuous cryo-miller (GSM 250 from Gotic) equipped with a 100×300 μm sieve. Powdered polyamide PA5 was then mixed with fumed silica (0.2 wt % of Cabosil® M5 from Cabot Corporation U.S.A. and 0.2 wt % Aerosil R812 from Evonik) to afford 3D printable powder PP5.

The Hausner ratio of 3D printable powder PP5 is of 1.233 [Ø] with an initial bulk density of 0.471 g·cm³.

Four kg of 3D printable powder PP5 were used to prepare a 3D printed article by laser sintering printing using a Formiga P110 from EOS. The laser parameters were as follows: power at 12 W/14 W, hatching distance at 0.15 mm, speed at 3500 mm·second. The printer parameters were as follows: chamber temperature at 171° C. and tank temperature at 135° C.

H1 tensile specimens (ISO 527) were printed and unpacked from the building “cake” with an excellent dimensional stability (no bending) after the end of printing.

### Example 6

Using a 110 L/D (diameter: 32 mm) twin-screw extruder as continuous reactor, m-xylylenediamine (136.19 g·mol⁻¹), trimethylhexamethylene diamine (158.28 g·mol⁻¹) and sebacic acid (202.25 g·mol⁻¹) were polymerized using process described in patent application WO 2014/016521 to produce a polyamide PA6 with a MVR of 45 cm³/10 min.

Polyamide PA6 was produced from 11974 g of m-xylylenediamine, 3479 g of trimethylhexamethylene diamine, 206900 g of sebacic acid, and 33.1 g of phosphoric acid (H₃PO₄). Trimethylhexamethylene diamine represents 20% (mol/mol) of the diamine content. No filler or other additive was added to polyamide PA6.

A twenty-five kilograms sample was grinded using a continuous cryo-miller (GSM 250 from Gotic) equipped with a 100×300 μm sieve. Powdered polyamide PA6 was then mixed with fumed silica (0.2 wt % of Cabosil® M5 from Cabot Corporation U.S.A. and 0.2 wt % Aerosil R812 from Evonik) to afford 3D printable powder PP6.

The Hausner ratio of 3D printable powder PP6 is of 1.202 [Ø] with a bulk density of 0.427 g·cm³.

Four kg of this 3D printable powder PP6 were used to prepare a 3D article by laser sintering printing using a Formiga P110 from EOS. The laser parameters were as follows: power at 12 W/14 W, hatching distance at 0.15 mm, speed at 3500 mm·second. The printer parameters were as follows: chamber temperature at 154° C. and tank temperature at 130° C.

Seven H1 tensile specimens (ISO 527) were printed and unpacked from the building “cake” with an excellent dimensional stability (no bending) after the end of printing.

### Example 7

Using a 110 L/D (diameter: 32 mm) twin-screw extruder as continuous reactor, m-xylylenediamine (136.19 g·mol⁻¹), sebacic acid (202.25 g·mol⁻¹) and polyamide 10,10 (MVR of 18 cm³/10 min at 240° C.) were introduced and polycondensed using process described in patent application WO 2014/016521. A polyamide PA7 with a MVR of 18 cm³/10 min is obtained. The polyamide 10,10 was previously prepared from sebacic acid (202.25 g·mol⁻¹ and 1-10 decanediamine (172.31 g·mol⁻¹) using process described in patent application WO 2014/016521.

Polyamide PA7 was produced from 4451 g of m-xylylenediamine, 6368 g of sebacic acid, 25300 g of polyamide 10,10 and 33.1 g of phosphoric acid (H₃PO₄). Polyamide 10,10 represents 70% (g/g) of the reaction media content. No filler or other additive was added to polyamide PA7.

A twenty-five kilograms sample was grinded using a continuous cryo-miller (GSM 250 from Gotic) equipped with a 125×125 μm sieve. Powdered polyamide PA7 was then mixed with fumed silica (0.2 wt % of Cabosil® M5 from Cabot Corporation and 0.2 wt % Aerosil R812 from Evonik to afford 3D printable powder PP7.

The Hausner ratio of 3D printable powder PP7 is of 1.23 [Ø] with an initial density of 0.52 g·cm³.

Four kg of this 3D printable powder PP7 were used to prepare a 3D article by laser sintering printing using a Formiga P110 from EOS. The laser parameters were as follows: power at 12 W/14 W, hatching distance at 0.15 mm, speed at 3500 mm·second. The printer parameters were as follows: chamber temperature at 177° C. and tank temperature at 150° C.

Seven H1 tensile specimens (ISO 527) were printed and unpacked from the building “cake” with an excellent dimensional stability (no bending) after the end of printing.

### Example 8

The properties of the 3D printable powders of the invention and the printed part thereof are illustrated in tables 1 to 4 below.

The granulometry of 3D printable powders PP1, PP2.1, PP2.2, PP3, PP4, PP5, PP6 and PP7 is reported in table 1 below.

TABLE 1

| | | | |
|---|---|---|---|
| D10 | D50 | D90 | D99 |

| | | | | | | | |
|---|---|---|---|---|---|---|---|
| PA1 | 22.9 μm | 52.1 | μm | 93.5 | μm | 130 | μm |
| PP2.1 | 13.8 μm | 35.5 | μm | 66.2 | μm | 94 | μm |
| PP2.2 | 13.8 μm | 35.5 | μm | 66.2 | μm | 94 | μm |
| PP3 | 14.8 μm | 34.5 | μm | 61.6 | μm | 85.3 | μm |
| PP4 | 12.5 μm | 33.7 | μm | 63.9 | μm | 91.2 | μm |
| PP5 | 17.9 μm | 52.4 | μm | 105 | μm | 154 | μm |
| PA6 | 26.9 μm | 65 | μm | 124 | μm | 179 | μm |
| PA7 | 16.6 μm | 44.6 | μm | 83.7 | μm | 119 | μm |

All 3D printable powders have satisfactory granulometry.

The mechanical properties of 3D printed parts obtained from the exemplified 3D printable powders are reported in table 2. The results were obtained after a 48 h conditioning at 23° C. and 50% relative humidity for 3D printable powders PP1, PP2.1, PP2.2, PP4, PP5, PP6 and PP7, and after (A) 336 h at 80° C. under vacuum and (B) 336 h at 70° C. at 62% humidity for PP3.

TABLE 2

| | Young | | | | |
|---|---|---|---|---|---|
| | modulus | Stress at | Strain at | Stress at | Strain at |
| | (MPa) | yield (MPa) | yield (%) | break (MPa) | break (%) |
| PP1 | 3900 +/− | | | 71 +/− | 2.8 +/− |
| | 8 | | | 2 | 0.12 |
| PP2.1 | 3740 +/− | — | — | 70 +/− | 3 +/− |
| | 22 | | | 2 | 0.09 |
| PP2.2 | 3870 +/− | — | — | 73.5 +/− | 3.2 +/− |
| | 31 | | | 10 | 0.6 |
| PP3 | 3816 +/− | — | — | 75 +/− | 2.6 +/− |
| (A) | 101 | | | 4 | 0.3 |
| PP3 | 3663 +/− | — | — | 61 +/− | 2.3 +/− |
| (B) | 87 | | | 6 | 0.5 |
| PP4 | 3780 +/− | — | — | 80 +/− | 3.7 +/− |
| | 29 | | | 1 | 0.15 |
| PP5 | 3790 +/− | — | — | 70 +/− | 3.0 +/− |
| | 22 | | | 3 | 0.16 |
| PP6 | 3320 +/− | — | — | 53 +/− | 2.4 +/− |
| | 40 | | | 2 | 0.22 |
| PP7 | 2010 ± | 59.8 ± | 4.0 ± | 46.1 ± | 10 ± |
| | 15 | 0.7 | 0.03 | 1 | 0.73 |

All 3D printed articles obtained from the exemplified 3D printable powders have Young modulus of at least 2 GPa. Compared to 3D printable powders from examples 1 to 6, 3D printable powder PP7 allows an improved elongation at break of 10% while having a modulus of 2000 MPa.

Recycling of PP1 has also been studied (by using 100% of recycled powder for the printing) and the mechanical properties after each cycle have been evaluated. Results are reported with the melt viscosity in table 3 below.

TABLE 3

| | Young | Stress at break | Strain at break | Melt viscosity |
|---|---|---|---|---|
| Cycle | modulus (MPa) | (MPa) | (%) | (cm³/10 min) |
| 1 | 3900 ± 8 | 71 ± 2 | 2.8 ± 0.12 | 21 |
| 2 | 3880 ± 31 | 69 ± 6 | 2.5 ± 0.26 | 30 |
| 3 | 3860 ± 36 | 68 ± 4 | 2.7 ± 0.24 | 26 |
| 4 | 3840 ± 30 | 71 ± 5 | 2.9 ± 0.31 | 21 |
| 5 | 3930 ± 55 | 77 ± 4 | 3.1 ± 0.26 | 15 |
| 6 | 3880 ± 38 | 72 ± 4 | 2.9 ± 0.24 | 26 |
| 7 | 3820 ± 29 | 69 ± 4 | 2.8 ± 0.23 | 19 |

As shown in table 3, the mechanical properties are good and conserved after 7 cycles without addition of new powder.

The thermal behaviour of 3D printable powders PP1, PP2, PP3, PP4, PP5, PP6 and PP7 were determined by DSC scan (10° C./min). Results are reported in table 4 below.

TABLE 4

| | | | | | Onset | | | |
|---|---|---|---|---|---|---|---|---|
| | Onset | | Melting | | crystal- | | Crystal- | En- |
| | melting | | peak | | lization | | lization | thalpy |
| | temper- | | temper- | | temper- | | temper- | of |
| | ature | | ature | | ature | | ature | fusion |
| PP1 | 181° | C. | 192° | C. | 144° | C. | 129° C. | 44 J/g |
| PP2 | 182° | C. | 192° | C. | 147° | C. | 138° C. | 42 J/g |
| PP3 | 182° | C. | 192° | C. | 146° | C. | 135° C. | 42 J/g |
| PP4 | 176° | C. | 187° | C. | 143° | C. | 133° C. | 39 J/g |
| PP5 | 176° | C. | 186.5° | C. | 140.8° | C. | 122° C. | 45 J/g |
| PP6 | 166.7° | C. | 176.2° | C. | — | | — | 20 J/g |
| PP7 | 176.1° | C. | 191.3° | C. | 153.3° | C. | 144.6° C. | 54 J/g |

Compared to 3D printable powders from examples 1 to 5, 3D printable powder PP6 containing 20% of amine comonomer III has a reduced crystallization rate and the onset crystallization temperature and the peak could not be measured.

1.-18. (canceled)

19. A 3D printable powder comprising:
a polyamide (PA) of the following formula: 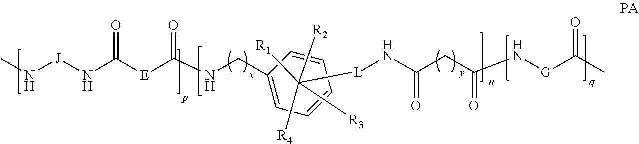
wherein:
-E- and -J- are identical or different and represent independently from one another a linear or branched, cyclic or acyclic alkylene, or an aromatic bivalent moiety,
-G- represents a linear or branched, cyclic or acyclic alkylene,
-L- represents —(CH₂)ₛ with s being an integer ranging from 0 to 6, or 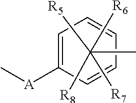
-A- represents —(CH₂)ᵣ— with r being an integer ranging from 1 to 6, a cyclohexylene group, —C(CH₃)₂—, —C(CF₃)₂—, —O—, —O—(CH₂)_{z}—O— with z being an integer ranging from 2 to 12, —O—(CH₂)₂—O—(CH₂)₂—O—(CH₂)₂—O—, —O-Ph-O—, —S—, —S—S—, —S—(CH₂)₃—S—, —CO— or —SO₂—,
—R1, —R2, —R3, —R4, —R5, —R6, —R7 and —R8 are identical or different and represent independently from one another —H, a (C1-C6) alkyl group, —Cl, —Br, or —I,
x is an integer ranging from 0 to 6,
y is an integer ranging from 2 to 11,
n+p+q=1, provided that p≠0 and q=0, or p=0 and q≠0, or p≠0 and q≠0, and
n≥0.1,
and less than 5 wt % of at least one filler relative to the weight of the 3D printable powder.

20. The 3D printable powder according to claim 19 wherein the polyamide (PA) is prepared from the following comonomers:
a diamine of formula (I): 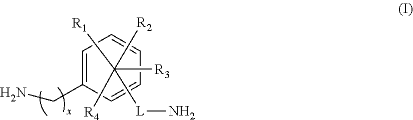
a diacid of formula (II):
HOOC—(CH₂)_{y}—COOH (II)
and at least one additional comonomer (III) chosen from linear or branched, cyclic or acyclic aliphatic, or aromatic diacids or diamines, or aliphatic aminoacids.

21. The 3D printable powder according to claim 20 wherein the diamine (I) is selected from the group consisting of m-phenylenediamine, p-phenylenediamine, p-xylylenediamine, m-xylylenediamine, 3,4′-diaminodiphenyl ether, 4,4′-diaminodiphenyl ether, 4, 4′-diaminodiphenyl sulfone, 3,3′-diaminophenyl sulfone, 4,4′-diaminodiphenyl sulphide, 4-aminophenyldisulfide, 4,4′-diaminobenzophenone, 4,4′(ethane-1,2-diylbis(oxy))dianiline, 4,4′(trimethylenedioxy)dianilin, 4,4′-(tetramethylenedioxy)dianiline, 4,4′-(pentamethylenedioxy)dianiline, 4,4′-(hexamethylenedioxy)dianiline, 4,4′-dodecanediyldioxy-di-aniline, 2,2′-[1,2-ethanediylbis(oxy-2,1-ethanediyloxy)]dianiline, 3,3′-[1,4-phenylenebis(oxy)]dianiline, 2,2′-(1,3-propanediyldisulfanediyl)dianiline, 4,4′-diaminodiphenylmethane, 4,4′-diaminodiphenylethane, 4,4′-(propane-2,2,diyl)dianiline, 4,4′-cyclohexylidene dianiline, and 4,4′-(hexafluoroisopropylidene)dianiline.

22. The 3D printable powder according to claim 20 wherein the diacid (II) is selected from the group consisting of sebacic acid, adipic acid and dodecandioic acid.

23. The 3D printable powder according to claim 20 wherein the polyamide (PA) is prepared from diamine (I), diacid (II) and from 1 to 90 mol % of at least one additional comonomer (III).

24. The 3D printable powder according to claim 23 wherein the at least one additional comonomer (III) is selected from the group consisting of a diamine, a diacid, and an aminoacid.

25. The 3D printable powder according to claim 19 wherein the polyamide (PA) has an average molecular weight by number Mn of at least 10 000 g·mol⁻¹.

26. The 3D printable powder according to claim 19 comprising less than 2 wt % of filler(s) relative to the weight of the 3D printable powder.

27. The 3D printable powder according to claim 19 futher comprising at least one additive selected from the group consisting of flow aid(s), retarding agent(s), impact modifier(s), antioxidant(s), co-crystallizer(s), plasticizer(s), dye(s), thermal stabilizer(s), antistatic agent(s), waxe(s), anti-nucleating agent(s) and compatibilizer(s).

28. A process for the preparation of the 3D printable powder according to claim 19 comprising preparing the polyamide (PA) by polycondensation and a step of mixing with the at least one filler if present.

29. The process according to claim 28 wherein the polyamide (PA) is prepared according to the following steps that are carried out in a reactor:
i) formation of a salt (A) from diamine (I), diacid (II) and additional comonomer(s) (III),
ii) heating of the salt (A) under pressure,
iii) removing the water.

30. The process according to claim 28 wherein the polyamide (PA) is prepared according to the following steps:
a) introduction of diamine (I), diacid (II) and additional comonomer(s) (III) into an extruder including at least two conveying screws rotating co-rotatively,
b) mixing the comonomers,
c) polycondensing the comonomers by successively carrying out shearing and depressurization operations on the material conveyed by the conveying screws,
d) forming a plug of material continuously renewed by conveyance of the material on the conveying screws, between the mixing and polycondensation steps; said material plug consisting of the advancing material filling the whole space available for the passage of the material and forming an area which is hermetic to vapors, and notably to monomer vapors which may be generated.

31. The process according to claim 28 wherein the polyamide (PA) is prepared according to the following steps:
a′) introduction of a polymer (P) into an extruder including at least two conveying screws rotating co-rotatively, said polymer (P) being a homopolymer or copolymer of diamine (I) and/or diacid (II) and/or additional comonomer(s) (III),
b′) introduction of at least one comonomer selected from diamine (I), diacid (II) and additional comonomer(s) (III) into said extruder,
c′) mixing the polymer (P) and the at least one conomoner,
d′) polycondensing the polymer (P) and the comonomer(s) by successively carrying out shearing and depressurization operations on the material conveyed by the conveying screws,
e′) forming a plug of material continuously renewed by conveyance of the material on the conveying screws, between the mixing and polycondensation steps; said material plug consisting of the advancing material filling the whole space available for the passage of the material and forming an area which is hermetic to vapors, and notably to monomer vapors which may be generated.

32. A three-dimensional printed article made from the 3D printable powder according to claim 19.

33. The three-dimensional printed article according to claim 32 having a Young modulus of at least 2000 MPa measured according to NF EN ISO 527-2 and ASTM D638-08 standards.

34. The three-dimensional printed article according to claim 32 having a strength at break of at least 45 MPa measured according to NF EN ISO 527-2 and ASTM D638-08 standards.

35. A method for preparing a three-dimensional printed article according to claim 32 using a powder bed fusion process.

36. A method comprising manufacturing a three dimensional printed article comprising 3D printing with the printable powder according to claim 19.

37. The 3D printable powder according to claim 23 wherein the at least one additional comonomer (III) is selected from the group consisting of hexamethylene diamine, trimethylhexamethylene diamine, 4,4′-diaminodicyclohexylmethane, 1,3-bis(aminomethyl)cyclohexane, 1,2-diaminocyclohexane, isophorone diamine, decane diamine, hexanoic diacid, nonanoic diacid, decanoic diacid, dodecanoic diacid, aminohexanoic acid, 11-aminoundecanoic acid and 13-aminotridecanoic acid.
